(19) United States
(12) Patent Application Publication
(10) Pub. No.: US 2011/0127737 A1
(43) Pub. Date: Jun. 2, 2011

(54) WHEELED HAMPER SYSTEM

(76) Inventor: Vanessa Thomas Lee, Duluth, GA (US)

(21) Appl. No.: 12/901,411

(22) Filed: Oct. 8, 2010

Related U.S. Application Data
(60) Provisional application No. 61/265,965, filed on Dec. 2, 2009.

(51) Int. Cl. B62B 7/04

(52) U.S. Cl. 280/47.26

(57) ABSTRACT

An apparatus for providing improved transportability for a clothes hamper to and from a laundry facility comprising: a four-wheel assembly and an extendable handle assembly for removable attachment to an existing clothes hamper. The wheeled hamper system further comprises castors which may be rotatable through 360 degrees enabling the clothes hamper to be maneuvered in virtually any direction. At least two wheels of the wheeled hamper system may comprise a wheel brake thereby allowing the clothes hamper to remain stationary during non-use and in-use periods. The extendable handle assembly may be extended or retracted by a user allowing the clothes hamper to be easily pushed or pulled on either four wheels or two wheels. A hamper lid may further be removably attached to the clothes hamper by a hinge enabling the hamper lid to be swingably closed thereby securely retaining the contents of the clothes hamper during transport. In an alternative embodiment, the four-wheel assembly, extendable handle assembly, and hamper lid may be pre-installed to a clothes hamper.

### CROSS-REFERENCE TO RELATED APPLICATION

The present application is related to and claims priority from prior provisional application Ser. No. 61/265,965, filed Dec. 2, 2009 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The present invention relates generally to the field of clothes hampers and more specifically relates to a wheeled assembly for removable attachment to a clothes hamper.

2. Description of the Related Art

Clothes hampers are traditionally used as a container to hold worn and dirty clothes. The hamper provides a storage compartment for the soiled clothing. When the hamper is full, the user may then carry the hamper with the dirty clothes to the washing machine to wash and dry the clothing. The hamper may then be used once again to store the clean clothing while being transported from the laundry area to a location where the clothes are stored within the household (ie. bedroom, closet, bathroom, etc.). However, many times a full clothes hamper may be too heavy for some users to carry. For example, an elderly woman may not be able to carry a full hamper of clothes to and from the laundry area. A person who suffers from back problems may also have problems carrying a hamper containing a week's worth of worn clothes. Additionally, a user may have to walk a long distance to and from their laundry machine area. In college dormitories, a student may need to walk down a long hall to arrive at a shared laundry room. These problems may be compounded if the clothes are damp because of the increased weight or if the laundry facilities are located on a different floor.

Performing the task of washing and drying a load of laundry may be a strenuous task. It may be extremely difficult to lift a hamper filled with laundry, as noted in the above examples. The weight of the hamper may cause arm, shoulder, back and neck strains. The elderly and the disabled are especially susceptible to such injuries. Without assistance, it may be impossible for an individual to carry the hamper to and from the laundry facilities. Therefore, an object of the present invention is to provide an improved wheeled hamper assembly to assist a user in transporting his or her laundry. Therefore, a need exists to provide an attachable wheel and handle assembly to a clothes hamper to assist a user in transporting his or her clothing safely to and from the laundry area.

Various attempts have been made to solve the above-mentioned problems such as those found in U.S. Pat. Nos. 2008/0190722, 5,511,807, 2007/0187912, 6,805,225, 4,596,397, D256,423, and 6,805,225. This prior art is representative of rollably transportable storage compartments (ie. luggage, clothes hampers). None of the above inventions and patents, taken either singly or in combination, is seen to describe the invention as claimed. Ideally, a wheeled hamper should operate reliably and be manufactured at a modest expense. Thus, a need exists for a reliable, user-friendly wheeled hamper system for the easy and convenient transportation of dirty and clean clothes to avoid the above-mentioned problems.

### BRIEF SUMMARY OF THE INVENTION

In view of the foregoing disadvantages inherent in the known clothes hamper art, the present invention provides a novel wheeled clothes hamper system. The general purpose of the present invention, which will be described subsequently in greater detail, is to provide a four-wheel rollable assembly with an extendable handle assembly for removable attachment to an existing clothes hamper thereby providing an efficient transporting means for the hamper.

The present invention holds significant improvements and serves as a removably attachable wheeled hamper system. In a preferred embodiment, the wheeled hamper comprises a four-wheel assembly and an extendable handle assembly for removable attachment to an existing clothes hamper. The four-wheel assembly may comprise a clothes hamper base frame, at least four caster wheels, and at least four wheel fastening devices. The wheels may comprise castors rotatable through 360 degrees and may further comprise a braking device. The extendable handle assembly may comprise two sets of cylindrical metallic rods, a handle grip, and at least two brackets to secure the extendable handle assembly to the clothes hamper base frame and the existing clothes hamper. The handle is adjustable by the user to a comfortable position for pushing and/or pulling the device.

In an alternative embodiment, the wheeled hamper may be sold as a single unit with the wheel assembly and extendable handle assembly already installed to the clothes hamper. The wheeled hamper may further comprise a folding lid which may be opened and closed to retain the contents of the hamper.

In either embodiment of the wheeled hamper system, the clothes hamper may be pushed on four wheels or tilted onto two wheels and pulled by a user via the extendable handle. In this manner, the user will not have to carry a full hamper of clothes and risk injury, but may wheel the hamper to and from the laundry facility with ease.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, wheeled hamper system, constructed and operative according to the teachings of the present invention.

FIG. 1 shows a perspective view illustrating a wheeled hamper in an in-use condition, storing clothes to be washed, according to an embodiment of the present invention.

FIG. 2 is a perspective view illustrating the wheeled hamper in an in-use condition, being pushed on four wheels by a user, according to an embodiment of the present invention of FIG. 1.

FIG. 3 is a perspective view illustrating the wheeled hamper in an in-use condition, being pulled on two wheels by the user, according to an embodiment of the present invention of FIG. 1.

FIG. 4 is a perspective view illustrating an extendable handle assembly of the wheeled hamper in a retracted position according to an embodiment of the present invention of FIG. 1.

FIG. 5 a perspective view illustrating the wheel assembly and the extendable handle assembly of the wheeled hamper according to an embodiment of the present invention of FIG. 1.

FIG. 6 is a flowchart illustrating a preferred method of use of the wheeled hamper according to an embodiment of the present invention of FIGS. 1-5.

The various embodiments of the present invention will hereinafter be described in conjunction with the appended drawings, wherein like designations denote like elements.

### DETAILED DESCRIPTION

As discussed above, embodiments of the present invention relate to a wheeled hamper system and more particularly to a wheeled hamper system as used to improve the efficiency and ease in transporting dirty and clean clothes to and from a laundry facility.

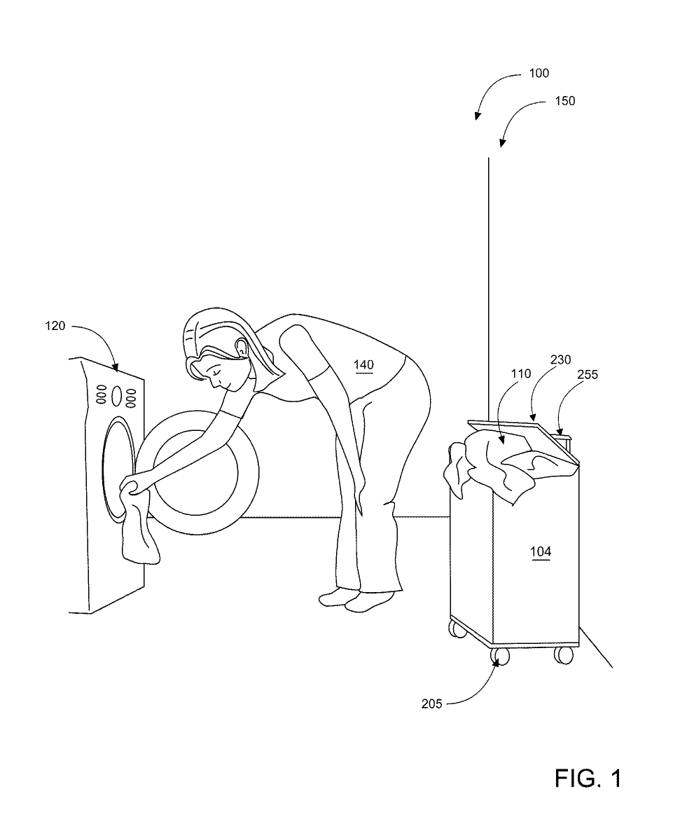

Referring to the drawings by numerals of reference there is shown in FIG. 1, a perspective view of wheeled hamper system 100 storing clothes 110 to be cleaned by user 140 in laundry machine 120. Wheeled hamper system 100 may comprise four-wheel assembly 400 and extendable handle assembly 500 which may be removably attached to clothes hamper 104. As seen in FIG. 1, wheeled hamper system 100 may store clothes 110 which are typically dirty while clothes hamper 140 remains in an idle position such that user 140 may conveniently move clothes 110 into laundry machine 120.

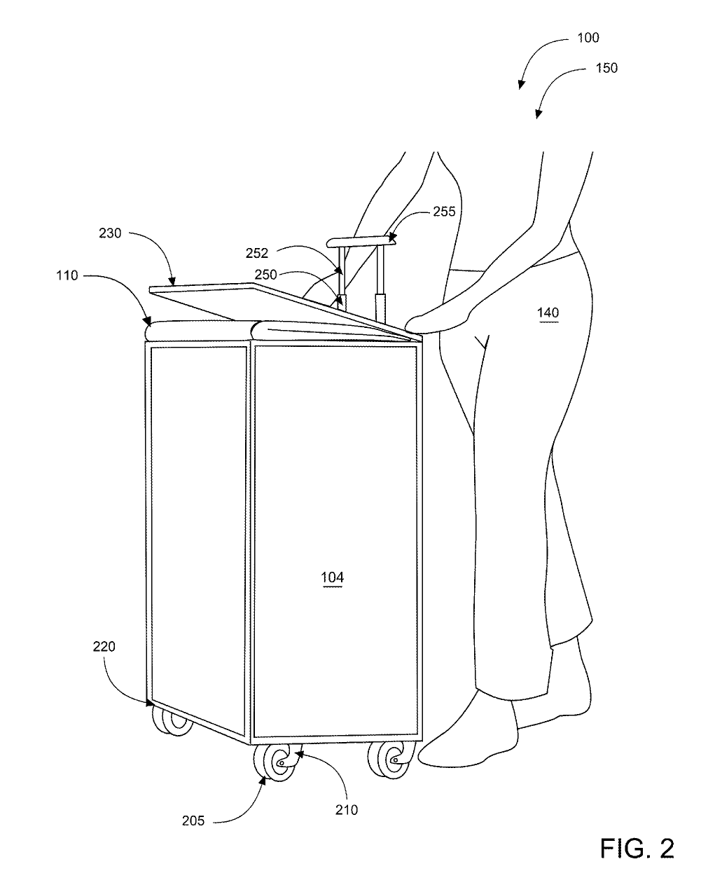

Referring now to FIG. 2, illustrating a perspective view of wheeled hamper system 100 in an in-use condition 150 being pushed on caster wheels 205 by user 140. Four-wheel assembly 400 may comprise clothes hamper base frame 200, at least four caster wheels 205, and at least four wheel fastening devices 210. Caster wheel 205 may be secured to clothes hamper base frame 200 by wheel fastening device 210. When caster wheels 205 are secured to clothes hamper base frame 200, four-wheel assembly 400 may be removably attached to bottom of clothes hamper 104. Hamper lid 230 may further be removably coupled to clothes hamper 104. As seen in FIG. 2, hamper lid 230 may be positioned by user 140 to rest on top of clothes 110 which may help retain clothes 110 during transport of wheeled hamper system 100.

As further seen in FIG. 2, wheeled hamper system 100 comprises caster wheels 205 which are rotatable through 360 degrees thereby substantially enabling clothes hamper 104 to be rolled in any direction by user 140. This may be especially advantageous when maneuvering clothes hamper 104 around obstacles and when shifting directions during transport.

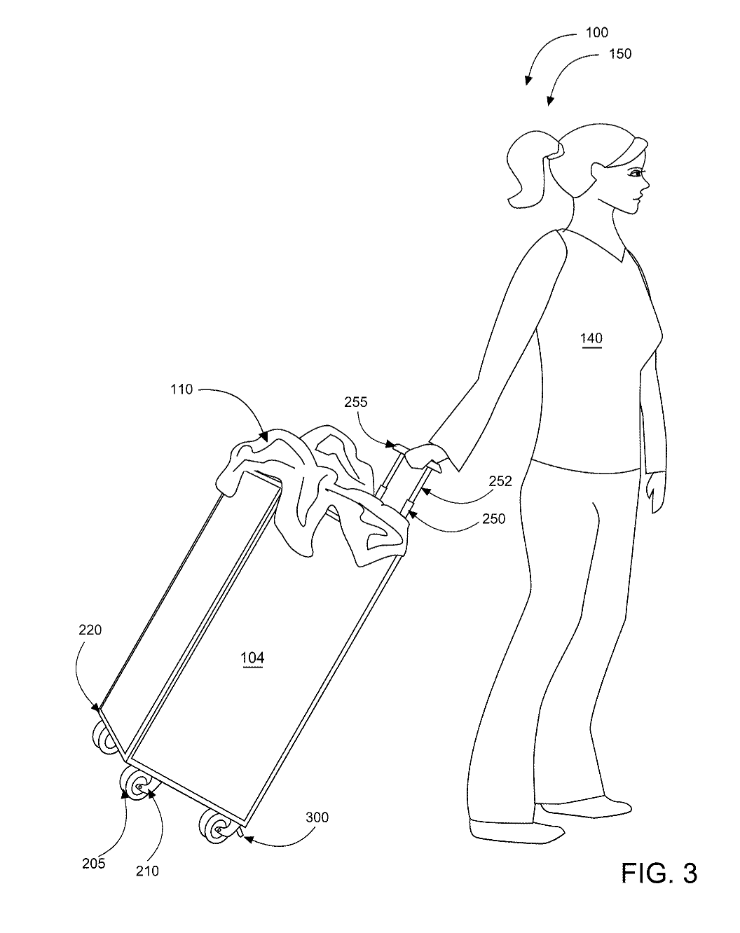

Referring now to FIG. 3, illustrating wheeled hamper system 100 in an in-use condition 150 being pulled by user 140 on only two of the wheels. As can best be seen in FIG. 3, caster wheel 205 may comprise wheel brake(s) 300. When wheel brake 300 is engaged, user 140 may easily tilt clothes hamper 104 onto two wheels. Wheel brake 300 may then be disengaged allowing clothes hamper 104 to be pulled by user 140 utilizing extendable handle assembly 500. This may be particularly useful when transporting clothes hamper 104 a long distance on a flat surface. As seen in FIG. 3, user 140 is transporting clothes hamper 104 containing clothes 110 to be washed. Further, braking means may be handy in instances where the planar surface that the device is being pulled on is not level to prevent undesirable rolling.

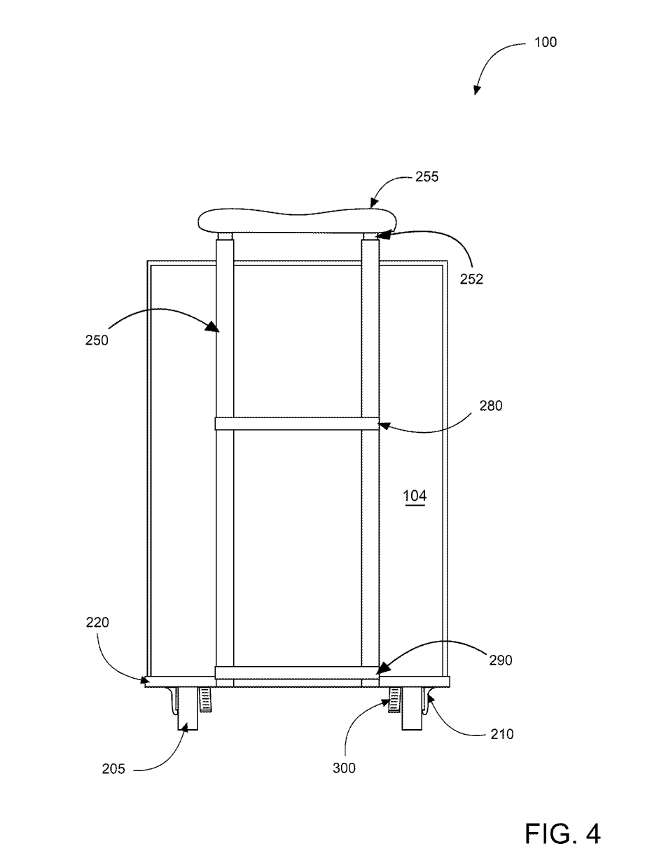

As seen in FIG. 4, extendable handle assembly 500 may comprise at least one, preferably two outer cylindrical rods 250, at least one, preferably two inner cylindrical rods 252, handle grip 255, stabilizing bracket 280, and bottom bracket 290. Each inner cylindrical rod 252 may be inserted into each outer cylindrical rod 250 and secured by handle grip 255 providing a telescopic means for extendable handle assembly 500. In an assembled condition, extendable handle assembly 500 may be removably attachable to four-wheel assembly 400 via bottom bracket 290 and to the back of clothes hamper 104 via stabilizing bracket 280. In such a manner, extendable handle assembly 500 may be retracted and extended by user 140 to facilitate in rolling clothes hamper 104. In this way the user may adjust the device to be comfortably maneuvered.

In an alternative embodiment, wheeled hamper system 100 may comprise four-wheel assembly 400 and extendable handle assembly 500 already attached to clothes hamper 104. In this fashion, wheeled hamper system 100 may be sold as a single unit and may further be manufactured in various sizes.

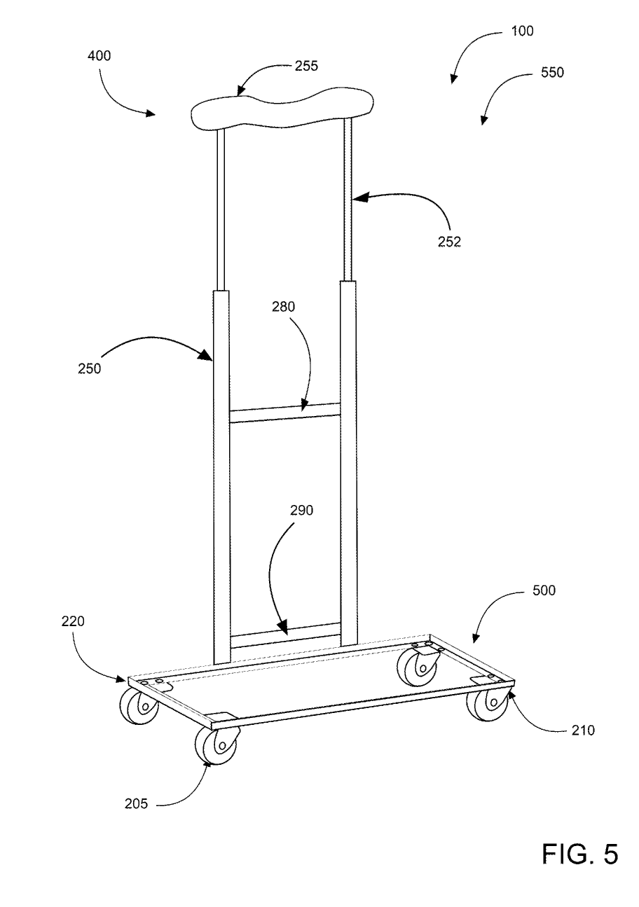

Referring now to FIG. 5, showing wheeled hamper system 100, wheeled hamper system 100 may be sold as kit 550 comprising the following parts: at least four caster wheels 205; at least four wheel fastening devices 210; at least one clothes hamper base frame 220; at least one hamper lid 230; at least two outer cylindrical rods 250; at least two inner cylindrical rods 252; at least one handle grip 255; at least one stabilizing bracket 280; at least one bottom bracket 290; and at least one set of user instructions. Wheeled hamper system 100 and four-wheel assembly 400 may be manufactured and provided for sale in a wide variety of sizes and shapes for a wide assortment of applications. As described above the device may be manufactured and/or sold integral with a clothes hamper or as a separate item. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components such as castor wheels, customized parts, different color combinations, hamper may be fastened in different orientations by different fastening means, parts may be sold separately, etc., may be sufficient.

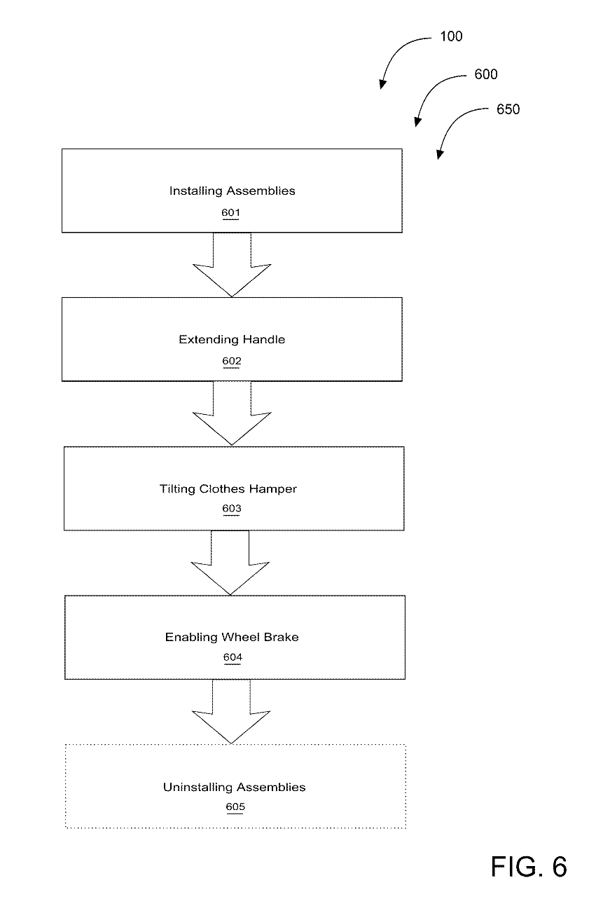

Referring now to FIG. 6, showing a flowchart 650 illustrating a method of use 600 according to an embodiment of the present invention of FIGS. 1-5. Method of use 600 for removably attaching wheeled hamper system 100 to clothes hamper 104 preferably comprising the steps of: step one 601 attaching four-wheel assembly 400 to base of clothes hamper 104 and attaching extendable handle assembly 500 to back of clothes hamper 104 via stabilizing bracket 280 and bottom bracket 290; step two 602 extending extendable handle assembly 500 to an up right position; step three 603 enabling wheel brake 300 on two caster wheels 205; and step four 604 tilting clothes hamper 104 onto two castor wheels 205 thereby enabling clothes hamper 104 to be pulled by user 140.

It should be noted that step five 605 is an optional step and may not be implemented in all cases. Optional steps of method 600 are illustrated using dotted lines in FIG. 6 so as to distinguish them from the other steps of method 600.

It should further be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A wheeled hamper system for removable attachment to an existing clothes hamper comprising:
at least one four-wheel assembly comprising at least one clothes hamper base frame, at least four wheels, and at least four wheel fastening devices;
at least one extendable handle assembly comprising at least two sets of cylindrical rods, at least one stabilizing bracket, at least one bottom bracket, and at least one handle grip;
at least one attachable hamper lid and at least one hinge;
wherein said four wheels are securable to said clothes hamper base frame by said wheel fastening devices;
wherein said sets of cylindrical rods of said extendable handle assembly are secured by said handle grip and by said stabilizing bracket and said bottom bracket;
wherein said attachable hamper lid is securable to said clothes hamper by said hinge; and
wherein said four-wheeled assembly and said extendable handle assembly are removably attachable to said existing clothes hamper thereby enabling said existing clothes hamper to be rolled on a surface.

2. The wheeled hamper system of claim 1 wherein said at least four wheels comprise castors which are rotatable through 360 degrees thereby enabling said existing clothes hamper to be rolled in any direction.

3. The wheeled hamper system of claim 2 wherein at least two of said four wheels comprise a brake device allowing said existing clothes hamper removably mounted on said four-wheeled assembly to remain stationary.

4. The wheeled hamper system of claim 1 wherein said extendable handle assembly comprises said at least two sets of said cylindrical rods which are telescopic.

5. The wheeled hamper system of claim 4 wherein said extendable handle assembly is extendable and retractable.

6. The wheeled hamper system of claim 1 wherein said existing clothes hamper is pushable by a user on said at least four wheels.

7. The wheeled hamper system of claim 1 wherein said existing clothes hamper is tiltable by said user onto two of said four wheels allowing said existing clothes hamper to be pulled by a user via said extendable handle assembly.

8. The wheeled hamper system of claim 1 wherein said at least two wheels comprise a brake device allowing said clothes hamper to remain stationary.

9. The wheeled hamper systems of claim 1 wherein said clothes hamper comprises said wheeled hamper system integrally and said four-wheel assembly and said extendable handle assembly are not removably attachable.

10. The wheeled hamper system of claim 1 wherein said four-wheel assembly is manufacturable in variable dimensions to fit clothes hampers of different shapes and sizes.

11. A wheeled hamper system comprising:
a clothes hamper;
a four-wheel assembly comprising a clothes hamper base frame, four wheels comprising casters rotatable through 360 degrees, and four wheel fastening devices;
a handle assembly comprising two sets of cylindrical rods, a stabilizing bracket, a bottom bracket, and a handle grip;
a hamper lid and a hinge;
wheel brakes for use with at least two of said four wheels to prevent movement of said four-wheeled assembly;
wherein said four wheels are securable to said clothes hamper base frame by said wheel fastening devices;
wherein said sets of cylindrical rods of said extendable handle assembly are secured by said handle grip, by said stabilizing bracket and by said bottom bracket;
wherein said hamper lid is attached to said clothes hamper by said hinge; and
wherein said four-wheeled assembly and said extendable handle assembly are attached to said clothes hamper thereby enabling said clothes hamper to be rolled on a planar surface.

12. The wheeled hamper system of claim 11 wherein said hamper lid is swingably closable to secure the contents within said clothes hamper during transport.

13. The wheeled hamper system of claim 11 wherein said wheeled hamper system further comprises a kit including said at least one four-wheel assembly, and said at least one extendable handle assembly in combination or not in combination with said existing hamper.

14. A method of using a wheeled hamper system comprising the steps of:
installing a four-wheel assembly and an extendable handle assembly via a stabilizing bracket and a bottom bracket to an existing clothes hamper;
extending said extendable handle assembly to an upright position;
enabling a wheel brake on at least two wheels of said four-wheel assembly; and
tilting said existing clothes hamper onto two wheels allowing said existing clothes hamper to be rollably maneuvered by a user via said extendable handle assembly.

15. The method of using a wheeled hamper system of claim 14 further comprising the step of:
uninstalling said four-wheel assembly and said extendable handle assembly from said existing clothes hamper.
